(19) United States
(12) Patent Application Publication
(10) Pub. No.: US 2003/0002280 A1
(43) Pub. Date: Jan. 2, 2003

(54) Integration systems of a reflector of light direction, placed into a watertight luminary of flourescent lamps

(76) Inventor: Antonios Paravantsos, Thessaloniki (GR)

Correspondence Address: THE LAW OFFICE OF CHARLES E. BRUZGA, 11 BROADWAY, STE 400, NEW YORK, NY, 10004, US

(21) Appl. No.: 10/148,789

(22) PCT Filed: Mar. 22, 2001
(86) PCT No.: PCT/GR01/00013

(30) Foreign Application Priority Data
Mar. 24, 2000 (GR) 20000100097

(51) Int. Cl. F21S 4/00

(52) U.S. Cl. 362/223; 362/225; 362/260

(57) ABSTRACT

Watertight luminary for fluorescent lamps (1) with incorporated catoptrical, or diffusive reflector (2) for light direction for the increase of its luminary efficiency. The metallic base (3) of the electrical components of the watertight luminary (1) is fixed at the bottom of the plastic base (4) so that it has smaller dimensions and, consequently, less material and lower assembling time comparing to the metallic base which would be fixed as a cover (8) in the open upper side of the plastic base. With the support of the metallic base (3) at the bottom of the plastic base (4) of the luminary, there is ample space in the upper open side of the plastic base (4) that allows the placement of the reflector (2) at the optimal distance from the fluorescent lamps (5) so that the desirable concentration and direction of light can be achieved. The reflector (2) for the light direction is shaped from plastic film of at least one reflective surface in an integrate form. The reduction of construction cost of the reflector (2) and of the metallic base (3) of electrical components in combination with the appropriate distance of the reflector (2) from the fluorescent lamps (5), allows the standard and permanent incorporation of the reflector (2) for light direction in the watertight fluorescent luminary (1) and results in the increase of its luminary efficiency by 15%.

The present invention relates to a waterproof and dustproof luminary (hereafter referred as watertight luminary), which has a built-in reflector, for the concentration and direction of the light emitted by the fluorescent lamps so that the light efficiency of the luminary can be increased.

The watertight luminaries that are presently in the market consist of a plastic base, which is fixed on the ceiling or the wall, of a metallic base (tray) supporting the electrical components and of a transparent diffuser cover, which, being properly tightened on the plastic base, seals perimetrically the luminary and do not let liquids or solid particles penetrate into the inner part of the luminary.

The metallic base supporting the electrical components that fits in today's watertight luminaries is painted in white and mostly flat iron plate, which carries all the electrical parts of the luminary. This metallic tray is placed on the upper, open side of the plastic base in such a way that the electrical parts are directed towards its inner part and the dimensions of the tray are designed so that it serves as a lid that covers the upper part of the base.

The fixing of the electrical components on the surface of the metallic tray requires that the tray is made of a strong material such as iron sheet. In addition to this, the fixing of the electrical components on the tray requires that its surface is flat and not of any other shape. The flat painted in white surface of the metallic tray provides a low degree of effusive reflection of the light and it lacks the possibility of concentrating and directing the light towards the serviceable area, which has to be lighted.

The light reflectors are divided into two main categories: the catoptrical reflectors and the diffusive ones. The catoptrical reflectors provide a perfect reflection and direction of the light to a concrete area. The effusive reflectors achieve to diffuse the light uniformly without distinguishing areas of higher or lower light intensity. The “forged” reflectors form a special category. They carry on their surface small polyhedral formations, which enhance the serviceable reflecting surface.

Some manufacturers of watertight luminaries offer the possibility of using a special reflector as an additional component, which the user buys separately at an extra cost. The construction material of these reflectors is thin aluminium sheet of at least one reflective surface. This sheet is shaped so as to concentrate and direct or diffuse the light output.

The extra cost of the aluminium reflector, due to the high price of the raw material, renders economically unprofitable its use by the client in watertight luminaries despite the fact that it increases their luminary efficiency by approximately 4-7%. Thus, the great majority of installed watertight luminaries have no aluminium reflector and, consequently, have lower light efficiency than the one that would be produced if luminaries were equipped with reflector of light direction. Even in case the reflector is used, the metallic base placed on the upper side of the plastic base does not provide the required space for placing the reflector at the optimal distance from the fluorescent lamps.

Furthermore, the aluminium reflectors, due to their metallic properties, their inflexibility and the sharpness of their edges, oblige the electrician-installer to pay particular attention during their placement or removal from the luminary in order not to be cut himself and not to injure the sensitive surface of the catoptrical aluminium from a random accident. In certain applications, the eventual fall of the aluminium reflector creates the danger of accident for the person or the object, which may be situated just underneath.

The invention, as described, aims to the elimination of problems concerning the wider use of catoptrical or diffusive reflector for light direction in watertight fluorescent luminaries. It gives the possibility of automated production of cheap reflector from special thin plastic film of at least one reflective surface, with specific gravity 1,35 gr/cm³, that is the half of the specific gravity of aluminium (2,7 gr/cm³). Consequently, the weight of the reflector made from special thin plastic film is approximately half the weight of a reflector of exactly the same form which would be made from the thinnest aluminium sheet existing in the market and as a result, there is a reduction in the cost of the material by 50%, according to the current price of the two aforementioned materials which is approximately the same.

This reflector is shaped of the plastic film in a thermo-mechanical way, through an automatic productive procedure in integrate forms and shapes so that the whole reflector constitutes only one piece and not assembly or union of separate parts. Thus, we achieve the reduced labor cost due to the way of production of the reflector from the special film.

We can characterize as a thin plastic film of at least one catoptrical surface the result of connection of a very thin membrane (approximately 0,015 mm) with a surface of very high catoptrical property on the thicker backing of some material, with thickness approximately 0,10-0,40 mm, such as PET, the polypropylene, the press-paper, the PVC and others.

Simultaneously, the invention achieves the reduction of the construction cost of this watertight luminary aiming to the possibility of permanent and standard incorporation of reflector for the light direction through it. This cost reduction is achieved by changing the way of support of the base of electrical components in the watertight luminary. According to the present invention, the metallic support base of the electrical components is fixed at the bottom of the plastic base of the watertight luminary and not as a cover in the upper open side of the plastic base. This allows the metallic base to have smaller dimensions, mainly width and thickness, since it does not need to cover like a lid the upper open side of the plastic base. There is an important reduction by 50% in the cost of the iron sheet material used for the construction of the metallic base of electrical components as well as a reduction of labor cost for its assembly, due to its smaller surface.

With the support of the metallic base at the bottom of the plastic base of the luminary, there is ample space in the upper open side of the plastic base that allows the placement of the reflector at the optimal distance from the fluorescent lamps so that the desirable concentration and direction of light can be achieved. Furthermore, the electrical components are visible and accessible to the installer, and there is no need to disconnect the metallic base from the plastic base, as it is the case until today with the known watertight luminaries existing in the market.

In the watertight luminary of the present invention, the reflector made from plastic film is also used, apart from its main property, as a light-weight cover of all electrical components placed in the interior of the plastic base making them invisible during the operation of the luminary.

The advantages of this invention are the following: the reduction of production cost of the reflector of at least one reflective surface made from plastic film used instead of aluminium reflector, the reduction of construction cost of the metallic base of electrical components, as well as the placement of this metallic base at the bottom of the plastic base of the luminary. All these advantages allow the permanent and stable use of catoptrical or diffusive reflector for light direction in this watertight luminary. This results in the improvement of its luminary efficiency by 15% and, consequently, the energy is saved by 15%, while, at the same time, the watertight luminary continues to be competitive since its final construction cost with built-in reflector of light direction is close to the construction cost of the respective watertight luminaries without aluminium reflector existing in the market.

Furthermore, the plastic material of the reflector eliminates the risk of cut injury of the installer because of sharp edges, and the flexibility of the plastic material makes it durable towards damage from mechanical pressure upon installation. Thanks to its very low weight, the plastic reflector is harmless in case it accidentally falls down from the ceiling.

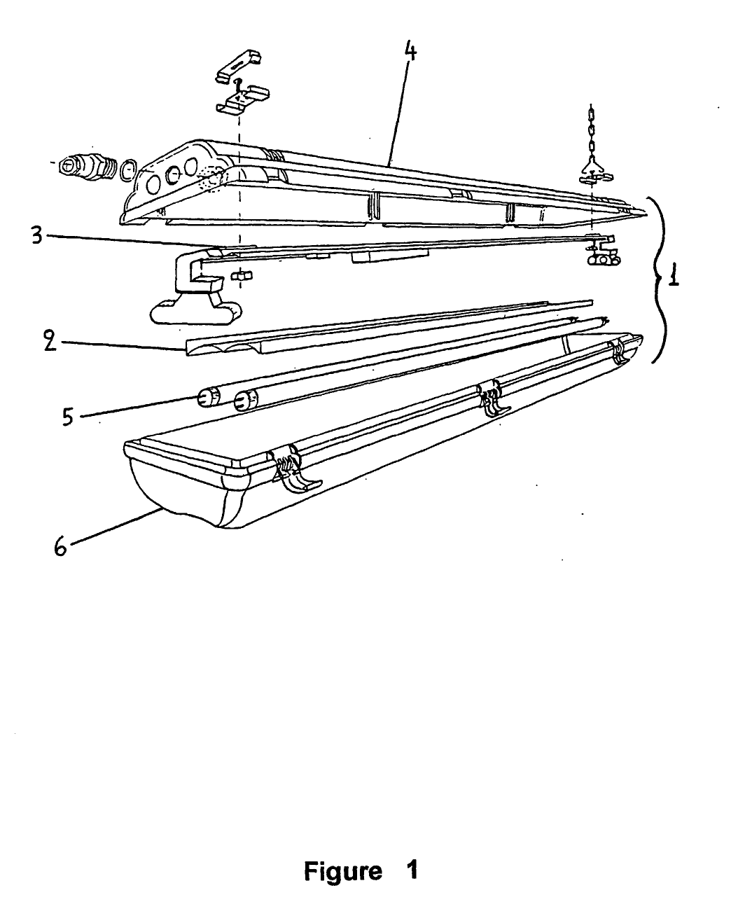

FIG. 1 is an overall perspective depiction of the watertight fluorescent luminary of the invention with axial transition of its components.

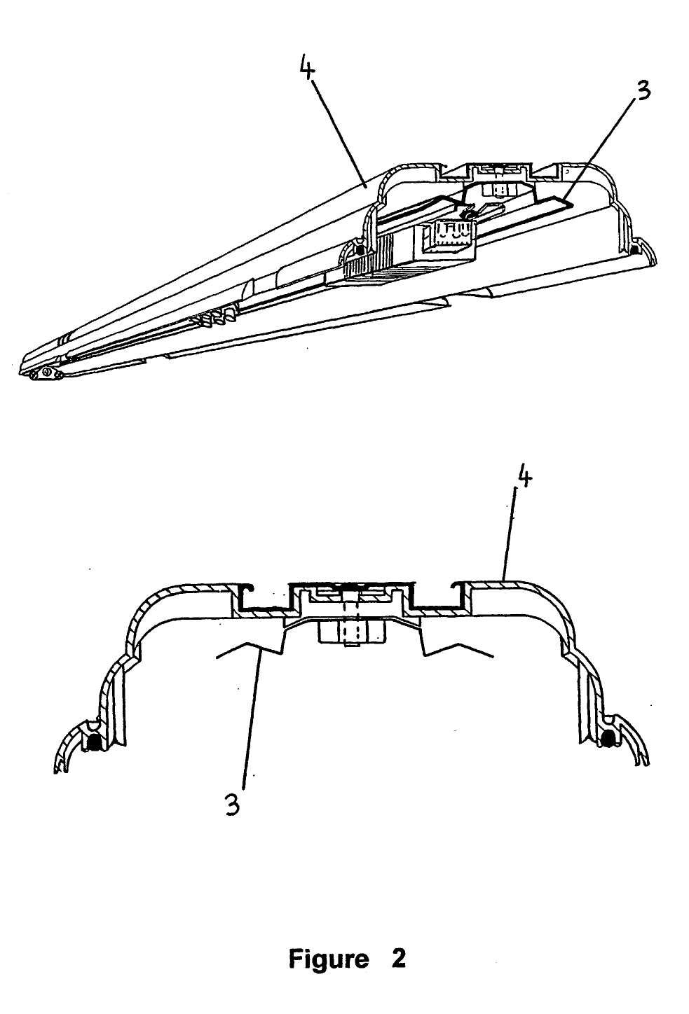

FIG. 2 is a transversal section and part of perspective depiction of the way the metallic base of electrical components is fixed at the bottom of the plastic base of the watertight luminary of the invention.

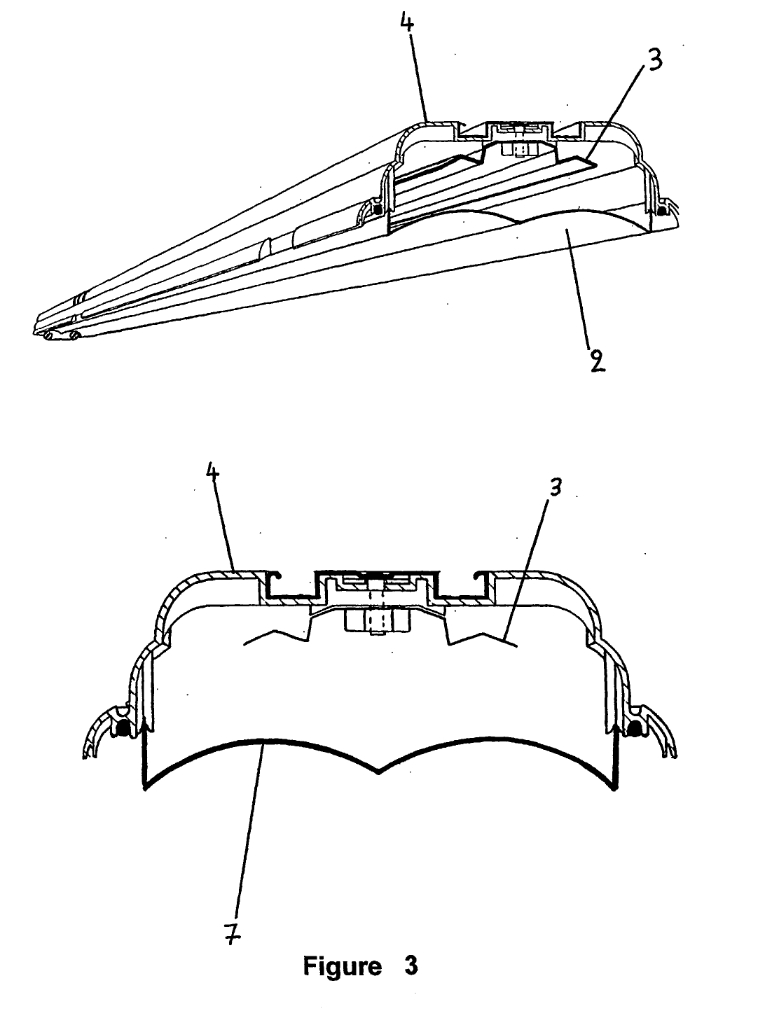

FIG. 3 is a transversal section and part of the perspective depiction of the reflector of light direction described in the invention, placed on the plastic base of the watertight luminary.

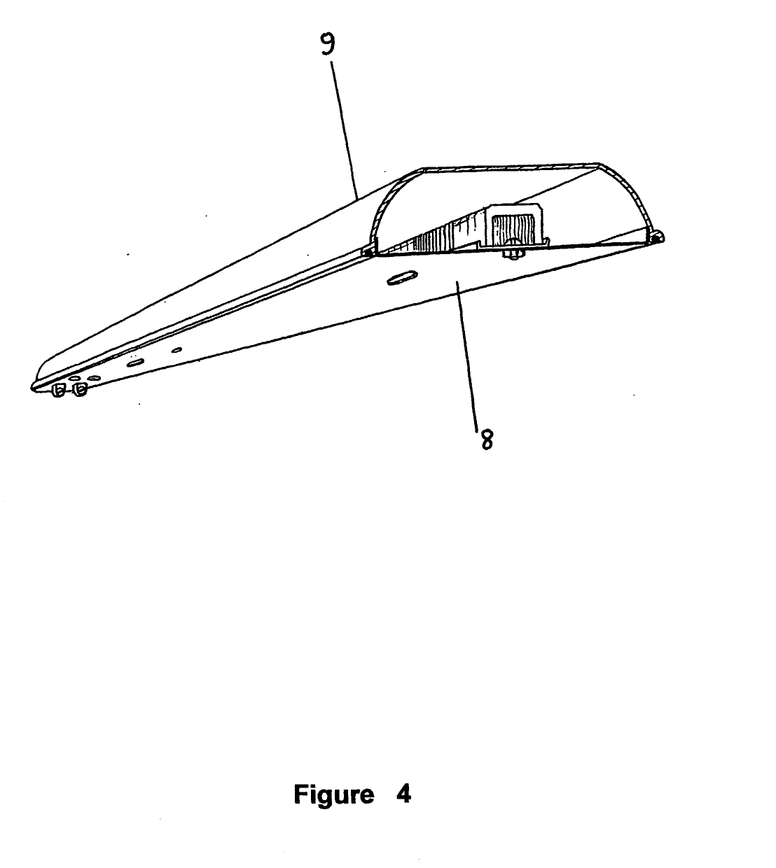

FIG. 4 is a perspective depiction of the way the metallic base of electrical components is fixed, applied in all known, until today, watertight fluorescent luminaries of the market.

A way to apply the invention is described below with references to the drawings.

The watertight luminary for fluorescent lamps (1) consists of the metallic base (3) made from iron sheet for the support of electrical components, fixed at the bottom of the plastic base (4) of the luminary and the reflector (2) of light direction, manufactured in an integrate form (7) from thin plastic film of at least one reflective surface which is placed in the upper part of the plastic base (4) under the fluorescent lamps (5) and the transparent lid (6) which protects the watertight luminary (1).

According to the present invention, the metallic base (3) of electrical components has smaller dimensions and, consequently, fewer iron sheet material, since it is fixed at the bottom of the plastic base (4) and not as a cover (8) in the upper open side of the plastic base (9) as it is the case with the other known until today watertight fluorescent luminaries. Furthermore, the reflector (2) of thin plastic film of one reflective surface, thanks to its low specific gravity, is by 50% lighter than the reflector of exactly the same form manufactured from aluminium mirror. With automatic productive method, an integrated composed form (7) of the reflector (2) is achieved so that the reflector (2) can constitute only one piece and not assembly or union of separate parts.

Finally, the reduction of the production cost of the reflector (2) of plastic film instead of the aluminium mirror, the reduction of the construction cost of the metallic base (3) of electrical components and the reduction of labor cost for its assembly, allow the standard and permanent incorporation of the reflector (2) of light direction in the watertight luminary (1). Those properties in combination with the fact that the reflector (2) is provided with enough space so that it can be placed in the proper distance from the fluorescent lamps (5), result in the increase of its luminary efficiency by 15%, and respectively, saves energy by 15%, while the luminary's final construction cost is close to the construction cost of uniform watertight fluorescent luminaries which exist in the market and do not possess reflectors of light direction.

1. The integration system of reflector suitable for directing the light output placed into a watertight luminary of fluorescent lamps aims to the optimization of its luminary efficiency. The invention is characterized by the fact that the metallic base (3) that supports the electric components is fixed at the bottom of the plastic base (4) of the watertight luminary (1) contrary to other watertight luminaries whose metallic base (8), supporting the electric components, is placed as a cover in the open upper part of the plastic base (9), turned upside-down, with its electrical components hidden underneath the cover. Thus, by fixing the metallic base (4) with electric components at the bottom of the plastic base, the electrical components are directly visible and accessible for the electrician who will control and wire the luminary (1); the metallic base (3) supporting the electric components has smaller dimensions, mainly width and thickness, since it does not need to cover as s lid all the open upper part of the plastic base (4); and, finally, the free open upper part of the plastic base (4) allows the placing of the reflector (1) at the optimal distance from the fluorescent lamps (5) without the increase of the height of the luminary, so that the desirable concentrating and directing of the light is achieved, resulting in the increase of luminary efficiency by 15%.

2. The integration system of reflector suitable for directing the light output, placed into a watertight luminary of fluorescent lamps, aiming to the optimization of its luminary efficiency, according to the claim 1, is characterized by the fact that the reflector (2) for directing the light of the watertight luminary (1) is manufactured from a thin plastic film of at least one catoptrical surface which is shaped, through a production procedure, in a composed and integral form (7), so that the whole reflector (2) is one and only piece and not the assembly or connection of various pieces.

3. The integration system of reflector suitable for directing the light output, placed into a watertight luminary of fluorescent lamps, aiming to the optimization of its luminary efficiency, according to the claim 1, is characterized by the fact that the reflector (2) is used as a cover of all the electric components which are situated inside the plastic base (4) of the watertight luminary (1) in such a way that they are invisible during the operation of the luminary and a beautiful aesthetic result is achieved.

4. The integration system of reflector suitable for directing the light output, placed into a watertight luminary of fluorescent lamps, aiming to the optimization of its luminary efficiency, according to the claim 1, is characterized by the fact that the weight of the reflector (2) is approximately half the weight of a reflector of exactly the same form which would be made of the thinnest in the market aluminum sheet, so that we achieve a reduction by 50% of material cost according to the current price of the two above materials which is approximately the same.

5. The integration system of reflector suitable for directing the light output, placed into a watertight luminary of fluorescent lamps, aiming to the optimization of its luminary efficiency, according to the claim 1, is characterized by the fact that the shaping of the reflector (2) in an integrated form (7) is performed automatically during manufacturing with the help of a special machine which forms the plastic film of at least one catoptrical surface through a thermo-mechanical procedure in such a way that the labor cost of its production is reduced.

6. The integration system of reflector suitable for directing the light output, placed into a watertight luminary of fluorescent lamps, aiming to the optimization of its luminary efficiency, according to the claim 1, is characterized by the fact that the reduction in iron sheet materials due to smaller dimensions of the metallic base (3) of the electrical components fixed at the bottom of the plastic base (4) is approximately equal to the 50% of the material that would be needed if the metallic base of electrical components' support would be fixed as a cover (8) in the open upper part of the plastic base (4) of the watertight luminary, that is reduction of the material cost by 50% according to the current price of the iron sheet and the current price of the painting powder but also reduction of the labor cost for the assembly of the metallic base (3) due to its smaller surface.

7. The integration system of reflector suitable for directing the light output, placed into a watertight luminary of fluorescent lamps, aiming to the optimization of its luminary efficiency, according to the claim 1, and the dependent claims 2, 4, 5 and 6, is characterized by the fact that the reduction of production cost of the reflector (2) of plastic film of at least one reflective surface used instead of aluminum sheet as well as the reduction of construction and assembling cost of the metallic base (3) of the electrical components, allow the standard and permanent use of the reflector (2) for light direction in this watertight luminary (1), resulting in the increase of its luminary efficiency by 15%, and, consequently, to respective energy saving by 15% with final production cost of this watertight luminary (1) being close to the construction cost of the competitive watertight luminaries without aluminum reflector existing in the market.
